(19) United States
(12) Patent Application Publication
(10) Pub. No.: US 2007/0293232 A1
(43) Pub. Date: Dec. 20, 2007

(54) Wireless communication failure monitoring system and monitoring device

(75) Inventor: Nobuyuki Nonaka, Tokyo (JP)

Correspondence Address: SNIDER & ASSOCIATES, P. O. BOX 27613, WASHINGTON, DC, 20038-7613, US

(73) Assignees: Aruze Corp., Tokyo (JP); Seta Corp., Tokyo (JP)

(21) Appl. No.: 11/808,676

(22) Filed: Jun. 12, 2007

(30) Foreign Application Priority Data
Jun. 20, 2006 (JP) 2006-170396
Jun. 20, 2006 (JP) 2006-170397

(51) Int. Cl. H04Q 7/20

(52) U.S. Cl. 455/450

(57) ABSTRACT

A wireless communication failure monitoring system, having: a terminal device capable of transmitting and receiving data wirelessly; a wireless transmitting and receiving device that has a sensor for measuring an element that changes a communication environment in a wireless transmission channel between the terminal device and the wireless transmitting and receiving device; and a wireless communication failure monitoring device that receives a log, which is generated on the basis of a communication execution report indicating an execution result of wireless communication performed between the wireless transmitting and receiving device and the terminal device, and data indicating a result of measurement of the element outputted from the sensor, and determines the occurrence of a communication failure on the basis of this log.

### RELATED APPLICATIONS

This application claims the priorities of Japanese Patent Application Nos. 2006-170396 and 2006-170397 filed on Jun. 20, 2006, which are incorporated herein by reference.

### BACKGROUND OF THE INVENTION

1. Field of the Invention

The present invention relates to a wireless communication failure monitoring system and monitoring device.

2. Description of the Prior Art

With the development and spread of the wireless communication technology and network technology, a system using a reader and writer, an access point, or other wireless communication means with partially wireless data transmission channels started to become popular. For example, there are proposed a system that reads out a so-called RFID (wireless IC tag) by means of a reader and writer to provide a management system with a unique ID stored in the RFID, and a system that configures a wireless LAN by means of an access point and a PC having a wireless LAN connection function or a wireless LAN IP telephone terminal (Japanese Unexamined Patent Publication No. 2005-348286 and Japanese Unexamined Patent Publication No. 2005-341444, for example).

However, in such a system having the wireless communication means on some of the data transmission channels as described above, though influence on the wireless communication means depends on difference of frequency bands, the communication performance thereof is significantly affected by changes in the environment and the like. For example, there is generated a problem that communication speed and success rate of communication are reduced by the increase in floor noise, electric waves coming from adjacent rooms and buildings, and reflection and interception of electric waves caused by moving people or objects.

However, in the conventional system in which some of the wireless data transmission channels are wireless, even if a communication failure occurs in the data transmission channels due to changes in the communication situations, it is not possible to determine whether the communication failure originates from the data transmission, or whether the communication failure occurs because the RFID to be read is absence, because the PC or IP telephone terminal as the communication target is absence, because these elements are in a nonoperational state, or because the communication performance deteriorates due to age-related deterioration of the device, thus, as a result, the device (system) is not able to notify the manager of the occurrence of the communication failure.

On the other hand, according to the wireless communication system in which communication is performed by means of the partially wireless data transmission channels as described above, cables are not required, thus no space needs to be provided to install wiring or connect cables. Therefore, the advantage is that time and cost can be saved, and the terminal device can be installed or moved freely. On the other hand, the disadvantage is that, when a failure occurs, the communication is interrupted briefly and the communication speed decreases, causing a problem in operations.

In the case in which such failure occurs, the communication does not recover normally until the cause of the failure is removed, whereby exchange of information may be stopped, causing great confusion. Particularly in the case of a system in which highly urgent communication is performed, it is essential that a communication system including, for example, an IP telephone (wireless SIP phone) as a lifeline be restored promptly.

As a technology of promptly restoring a system in which at least some data transmission channels are wireless transmission channels, there is proposed a technology of detecting a failed condition in a monitored device connected to a wireless network, and then examining, restoring, or cutting off and restoring the power from a distant location to protect the system (Japanese Unexamined Patent Publication No. 2003-234838, for example).

In such a system having the wireless communication means on some of the data transmission channels as described above, though influence on the wireless communication means depends on difference of frequency bands, the communication performance thereof is significantly affected by changes in the environment and the like. For example, there is generated a problem that communication speed and success rate of communication are reduced by the increase in floor noise, noise that is generated from a new device installed in a personal room, electric waves coming from adjacent rooms and buildings, and reflection and interception of electric waves caused by moving people or objects, whereby a communication failure occurs within the system.

However, in the conventional technology described in Japanese Unexamined Patent Publication No. 2003-234838, even if the trouble within the device itself can be discovered, the communication failure that occurs in the wireless transmission channels cannot be detected. In the case in which a communication failure occurs on the data transmission channels performing wireless transmission due to changes in the communication situations, it is not possible in the conventional system to determine whether the communication failure originates from the data transmission, or whether the communication failure occurs because the RFID to be read is absence, because the PC or IP telephone terminal as the communication target connected to a wireless LAN is absence, because these elements are in a nonoperational state, because of changes in the operating environment, or because the communication performance deteriorated due to age-related deterioration of the device, thus, as a result, the device (system) is not able to notify the manager of the occurrence of the communication failure.

Unless a user discovers the decrease of the communication speed, the system using an RFID, the system without an operator that collects data using a wireless LAN (a machine or the system collects the data), and the system such as a security system in which some data transmission channels perform wireless communication can no longer perform communications, depending on changes in the communication environment. However, there is no method of notifying system users or system operators of that the system is unable to fulfill its primary function or that communications cannot be performed temporarily for some reasons. Moreover, it is not possible to do maintenance for removing such troubles. These problems are very serious problems especially in wireless SIP phones. The reason is that, although the number of wireless SIP phones will increase from now on because the old analog fixed networks will be changed, since telephones=lifelines, a situation where these phones cannot be used, even temporarily, becomes fatal for the telephone system, which is a part of lifelines.

### SUMMARY OF THE INVENTION

An object of the present invention is, in a system in which at least some data transmission channels perform wireless communication, to provide a technology of monitoring a communication failure that occurs due to changes in the communication environment, and reporting the occurrence of the failure according to need, and a technology that is capable of promptly providing a maintenance service for removing the communication failure.

As means for solving the above problems, the present invention has the following characteristics.

A first aspect of the present invention is a wireless communication failure monitoring system, which has: a terminal device (e.g., a RFID (wireless IC tag), wireless LAN PC, wireless SIP phone, etc.) capable of transmitting and receiving data; a wireless transmitting and receiving device (e.g., a reader and writer, access point, etc.) that exchanges data with the terminal device and has a sensor for measuring a communication environment variation element (e.g., a noise level, temperature, humidity, dew condensation, etc.) which changes a communication environment in a wireless transmission channel between the terminal device and the wireless transmitting and receiving device; and a wireless communication failure monitoring device that receives, from the wireless transmitting and receiving device, a log that is generated on a basis of a communication execution report, which is data indicating an execution result of wireless communication performed between the terminal device and the wireless transmitting and receiving device, and measurement result data indicating a result of measurement of the communication environment variation element outputted from the sensor, and determines the occurrence of a communication failure on the basis of the log.

According to this system, the occurrence of a communication failure is monitored, while detecting the variation or occurrence of the communication environment variation element, which is a cause of the communication failure. This system can monitor a communication failure caused by changes in the communication environment, and report the occurrence of the failure according to need.

Further, according to the system of the first aspect, the wireless transmitting and receiving device comprises: a wireless communication section that exchanges data with the terminal device; an environment measuring section that receives the measurement result data from the sensor and stores the measurement result data every time; and a log generating section that receives a communication execution report from the wireless communication section, receives the measurement result data from the environment measuring section, generates a log on the basis of the received communication execution report and measurement result data, and transmits the generated log to the monitoring device.

In addition, according to the system of the first aspect, a plurality of wireless transmitting and receiving devices is connected to the monitoring device.

Also, a second aspect of the present invention is also proposed as the wireless communication failure monitoring system.

This wireless communication failure monitoring system (e.g. a maintenance system) has: a terminal device (e.g., a wireless IC tag, wireless LAN PC, wireless SIP phone, etc.); a wireless transmitting and receiving device (e.g., a reader and writer, access point, etc.) that exchanges data with the terminal device and has a sensor for measuring a communication environment variation element (e.g., noise, temperature, humidity, dew condensation, etc.), which changes a communication environment in a wireless transmission channel between the terminal device and the wireless transmitting and receiving device; and a monitoring device having a monitoring section that receives, from the wireless transmitting and receiving device, a log that is generated on the basis of a communication execution report, which is data indicating an execution result of wireless communication performed between the terminal device and the wireless transmitting and receiving device, and measurement result data indicating a result of measurement of the communication environment variation element outputted from the sensor, determines the occurrence of a communication failure between the wireless transmitting and receiving device and the terminal device on the basis of the log, and executes predetermined processing for dealing with the communication failure on the basis of a result of the determination.

This wireless communication failure monitoring system can provide a maintenance service that monitors a communication failure caused by changes in the communication environment and fixes the communication failure.

In the wireless communication failure monitoring system, the predetermined processing may be a remote operation processing for causing the wireless transmitting and receiving device to perform adjustment to fix the communication failure. Such wireless communication failure monitoring system can automatically detect the occurrence of a communication failure to automatically fix the communication failure by means of remote operation, and thereby promptly provide the maintenance service for fixing the communication failure.

Furthermore, the wireless communication failure monitoring system may be further provided with a report output device for reporting the occurrence of a communication failure (e.g., a personal computer with a web browser, etc.), whereby the predetermined processing may be configured to transmit a report for fixing the communication failure, to the report output device corresponding to the wireless transmitting and receiving device.

Such wireless communication failure monitoring system can automatically detect the occurrence of the communication failure, provide information required for fixing the communication failure to an owner or manager of the wireless transmitting and receiving device, who is in a position to be able to rush to the wireless transmitting and receiving device promptly, and promptly perform maintenance to fix the communication failure by promoting responses to the communication failure.

Moreover, the wireless communication failure monitoring system may be further provided with a maintenance terminal device (e.g., a personal computer with a web browser, etc.) that displays a maintenance request message for sending a maintenance person to a location in which a wireless transmitting and receiving device having a communication failure is installed, whereby the predetermined processing may be configured to generate the maintenance request message for sending the maintenance person to the location in which the wireless transmitting and receiving device is installed, in order to fix the communication failure, and then transmit the maintenance request message to the maintenance terminal device.

Such wireless communication failure monitoring system can automatically detect the occurrence of a communication failure, perform the remote operation or dispatch a maintenance person, who is an expert at resolving the problem of a communication failure that cannot be resolved by the owner, manager, or the like of the wireless transmitting and receiving device, and thereby promptly provide the maintenance service for fixing the communication failure.

Further, in this wireless communication failure monitoring system, the wireless transmitting and receiving device comprises: a wireless communication section that exchanges data with the terminal device; an environment measuring section that receives the measurement result data from the sensor and stores the measurement result data every time; and a log generating section that receives a communication execution report from the wireless communication section, receives the measurement result data from the environment measuring section, generates a log on the basis of the received communication execution report and measurement result data, and transmits the generated log to the monitoring device.

In addition, according to the wireless communication failure monitoring system, in the monitoring device, when the measurement result causing a communication failure and a report situation of the communication execution report are shown as normal, maintenance responding processing is not performed but log analyzing processing based on the measurement result is performed; when the measurement result causing a communication failure and the report situation of the communication execution report are shown as abnormal, the log analyzing processing based on the measurement result and the maintenance responding processing are performed; and when the measurement result, which is an element causing a communication failure, is shown as abnormal but the report situation of the communication execution report is normal, the maintenance responding processing is not performed but the log analyzing processing based on the measurement result is performed.

A third aspect of the present invention is proposed as a monitoring device for monitoring a wireless communication failure. This monitoring device for monitoring a wireless communication failure has: a log storage section that receives from each wireless transmitting and receiving device and stores a log that is generated on the basis of a communication execution report indicating an execution result of wireless communication performed in the wireless transmitting and receiving device (e.g., a reader and writer, access point, etc.), and measurement result data outputted from the sensor; a log analyzing section that determines the occurrence of a communication failure on the basis of the log stored in the log storage section; and a reporting section that receives a command from the log analyzing section and executes predetermined reporting processing in response to the command.

According to this device, the occurrence of a communication failure is monitored, while detecting the variation or occurrence of the communication environment variation element, which is a cause of the communication failure. For each wireless transmitting and receiving device, this device can monitor a communication failure caused by changes in the communication environment, and report the occurrence of the failure according to need. Therefore, the time of occurrence, the place of occurrence, the cause of occurrence and the like can be recognized.

A fourth aspect of the present invention is also proposed as the monitoring device.

This monitoring device has: a log storage section that receives from each wireless transmitting and receiving device and stores a log that is generated on the basis of a communication execution report indicating an execution result of wireless communication performed in the wireless transmitting and receiving device (e.g., a reader and writer, access point, etc.), and measurement result data outputted from the sensor; a log analyzing section that determines the occurrence of a communication failure between the wireless transmitting and receiving device and the terminal device (e.g., a wireless IC tag, wireless LAN PC, wireless SIP phone, etc.) on the basis of the log stored in the log storage section; and a responding processing section that executes predetermined processing for dealing with the communication failure on the basis of the determination made by the log analyzing section.

This monitoring device can promptly provide a maintenance service that monitors a communication failure caused by changes in the communication environment, and fixes the communication failure, in a system that uses wireless transmission as at least partial data transmission channels.

In the monitoring device, the predetermined processing may be remote operation processing for causing the wireless transmitting and receiving device to perform adjustment to fix the communication failure. Such monitoring device can automatically detect the occurrence of a communication failure to automatically fix the communication failure by means of remote operation, and thereby promptly provide the maintenance service for removing the communication failure.

In the monitoring device, the predetermined processing may be configured to transmit a report for fixing the communication failure. Such monitoring device can automatically detect the occurrence of the communication failure, provide information required for fixing the communication failure to an owner or manager of the wireless transmitting and receiving device, who is in a position to be able to rush to the wireless transmitting and receiving device promptly, and promptly perform maintenance to fix the communication failure by promoting responses to the communication failure.

Moreover, in the monitoring device, the predetermined processing may be configured to generate the maintenance request message for sending the maintenance person to the location in which the wireless transmitting and receiving device is installed, in order to fix the communication failure, and then transmit the maintenance request message.

Such monitoring device can automatically detect the occurrence of a communication failure, perform the remote operation or dispatch a maintenance person, who is an expert at resolving the problem of a communication failure that cannot be resolved by the owner, manager, or the like of the wireless transmitting and receiving device, and thereby promptly provide the maintenance service for fixing the communication failure.

According to such monitoring device, when the measurement result causing a communication failure, and a report situation of the communication execution report are shown as normal, maintenance responding processing is not performed but log analyzing processing based on the measurement result is performed; when the measurement result causing a communication failure, and the report situation of the communication execution report are shown as abnormal, the log analyzing processing based on the measurement result and the maintenance responding processing are performed; and when the measurement result causing a communication failure is shown as abnormal but the report situation of the communication execution report is shown as normal, the maintenance responding processing is not performed but the log analyzing processing based on the measurement result is performed.

### BRIEF DESCRIPTION OF THE DRAWINGS

FIG. 1 is a block diagram showing a configuration example of a wireless communication failure monitoring system;

FIG. 2 is a block diagram showing a configuration example of a wireless transmitting and receiving device;

FIG. 3 is a figure showing an example of a data configuration of a communication situation report;

FIG. 4 is a figure showing an example of a data configuration of measurement result data;

FIG. 5 is a figure showing an example of a data configuration of a log;

FIG. 6 is a block diagram showing a configuration example of a communication failure monitoring device;

FIG. 7 is a timing chart showing an example of operation of a wireless communication failure monitoring device;

FIG. 8 is a block diagram showing a configuration example of a wireless communication failure monitoring system (maintenance system);

FIG. 9 is an enlarged block diagram showing sections centered around the wireless transmitting and receiving device of the wireless communication failure monitoring system (maintenance system);

FIG. 10 is a block diagram showing a configuration example of the wireless transmitting and receiving device;

FIG. 11 is a block diagram showing a configuration example of a monitoring server;

FIG. 12 is a flowchart showing an example of maintenance responding processing;

FIG. 13 is a timing chart showing an example of operation of the monitoring server;

FIG. 14 is a sequence diagram showing an example of operation of the maintenance system; and

FIG. 15 is a sequence diagram showing an example of operation of the maintenance system, subsequently to the operation example shown in FIG. 14.

### DESCRIPTION OF THE PREFERRED EMBODIMENTS

Hereafter, embodiments of the present invention are described with reference to the drawings. It should be noted that the respective constitutions shown in the following first and second embodiments will be combined together.

### First Embodiment

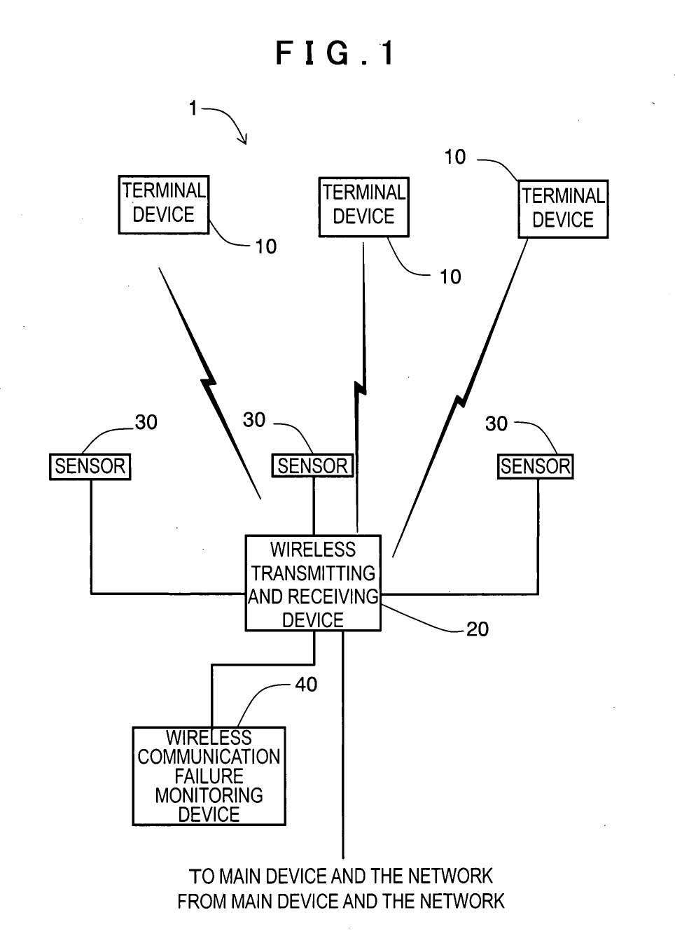

FIG. 1 is a block diagram showing a configuration example of a wireless communication failure monitoring system according to a first embodiment.

A wireless communication failure monitoring system 1 is a system for monitoring the occurrence of a communication failure.

This wireless communication failure monitoring system 1 has: one or a plurality of terminal devices 10; a wireless transmitting and receiving device 20 that wirelessly performs data transmission with the terminal device 10, the wireless transmitting and receiving device 20 having one or a plurality of types of sensors that measure an element changing a communication environment (referred to as “communication environment variation element” hereinafter) in a wireless transmission channel between the terminal device 10 and the wireless transmitting and receiving device 20; a wireless communication failure monitoring device 40 that receives, from the wireless transmitting and receiving device 20, a result of communication performed between the wireless transmitting and receiving device 20 and the terminal device 10 and a result of measurement of the communication environment variation element measured by the sensor 30, and monitors the occurrence of a communication failure on the basis of the received results.

[Terminal Device 10]

The terminal device 10 is a device that performs data transmission wirelessly with the wireless transmitting and receiving device 20. The terminal device 10 is, for example, a personal computer having a function that can be connected to a wireless IC tag or wireless LAN, a wireless IP telephone terminal (a wireless SIP phone, for example), and the like.

[Wireless Transmitting and Receiving Device 20]

The wireless transmitting and receiving device 20 exchanges data with the terminal device 10 by means of wireless transmission, and, according to need, transmits data received from the terminal device 10 to a main device or network, or transmits data received from the main device or network to the terminal device 10.

Also, the wireless transmitting and receiving device 20 transmits, to the wireless communication failure monitoring device 40, a communication environment log, which is data configured by an execution report and measurement result data, the execution report being a report on an execution state of the data transmission performed between the wireless transmitting and receiving device 20 and the terminal device 10, and the measurement result data being a result of measurement detected by the sensor 30.

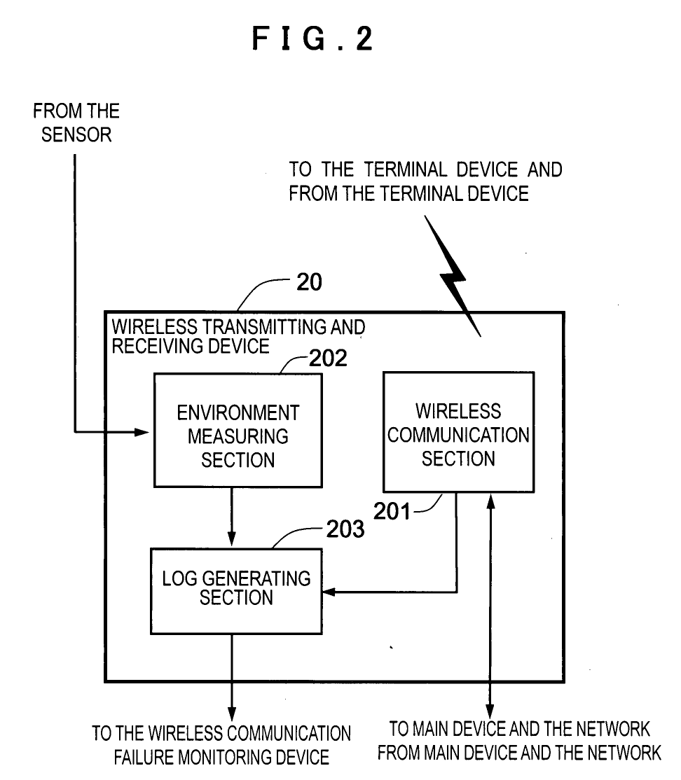

FIG. 2 is a block diagram showing a configuration example of the wireless transmitting and receiving device 20. The wireless transmitting and receiving device 20 has a wireless communication section 201 that exchanges data with the terminal device 10 by means of wireless transmission, an environment measuring section 202 that receives the measurement result data from the sensor 30 and stores this data every time, and a log generating section 203 that receives a communication execution report from the wireless communication section 201, receives the measurement result data from the environment measuring section 202, generates a communication environment log on the basis of the received report and data, and transmits the generated communication environment log to the wireless communication failure monitoring device 40.

[Wireless Communication Section 201]

The wireless communication section 201 modulates transmission data and demodulates received data to exchange data with the terminal device 10 by means of wireless transmission. Furthermore, the wireless communication section 201 outputs the communication execution report, which is data indicating the execution state of the communication performed between the wireless communication section 201 and the terminal device 10. For example, the wireless communication section 201 outputs, as the communication execution report, time at which a call is sent to the terminal device 10, and a situation in which a response is received from the terminal device 10 as a result of the call.

Moreover, in the case in which a plurality of different frequency bands (channels) can be used in data transmission, the wireless communication section 201 includes, in the communication execution report, a situation in which the frequency bands are switched, a call sent to each terminal device 10 in each frequency band, time at which the call is sent, and a situation in which a response is received from the terminal device 10 as a result of the call, and outputs this communication execution report.

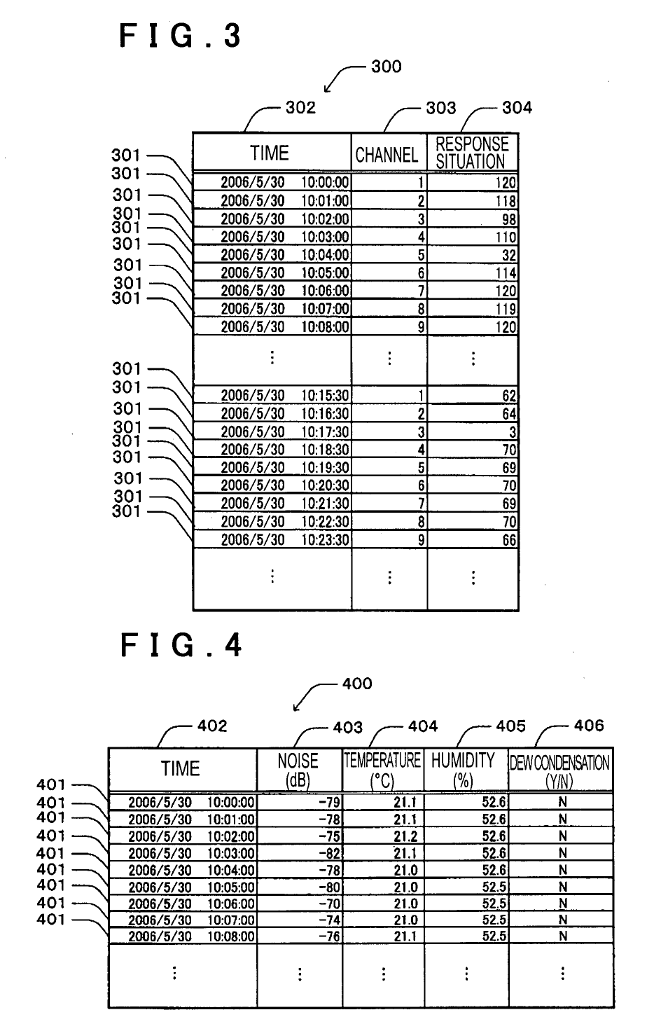

FIG. 3 shows an example of the communication execution report outputted by the wireless communication section 201. In this example, a reader and writer is used as the wireless transmitting and receiving device 20. This reader and writer calls a wireless IC tag, which is the terminal device 10, while preventing an interference among the channels by means of a normal LBT function or the like and sequentially switching nine channels of 1 through 9 channels. A communication execution report 300 generates one record 301 every time when a process of calling the wireless IC tag is performed for each channel. The record 301 has a time field 302, a channel field 303, and a response situation field 304. The time field 302 is a field for storing the time (date and time) at which the processing for calling the wireless IC tag is executed. The channel field 303 is a field for storing a channel number that is used in the calling processing. The response situation field 304 is a field for storing the number of wireless IC tags, that is, the number of terminal devices 10 responding in the calling processing. The example in FIG. 3 shows the communication execution report 300 for the case in which the processing for calling the wireless IC tag is performed while switching the channel every minute since the time “2006/5/30 10:00:00”. The communication execution report stores that the calling processing is performed using the channel 1 through the channel 9 between the time “10:00:00” and the time “10:08:00”. When looking at the values shown in the response situation field 304 of the corresponding record, the number of wireless IC tags, i.e., terminal devices 10, that respond at the channel 5 is extremely smaller, compared to the channels 1 through 4 and 6 through 9, thus it is estimated that some kind of a communication failure occurs in the frequency band of the channel 5 during this time zone.

The calling processing using the channel 1 through the channel 9 is repeated. In the example shown in FIG. 3, the calling processing from the channel 1 through the channel 9 is performed between “10:15:30” and “10:23:30”. When looking at the values shown in the response situation field 304 of the corresponding record, the number of wireless IC tags, i.e., terminal devices 10, that respond at the channel 3 is extremely smaller, compared to the channels 1 through 2 and 4 through 9, thus it is estimated that some kind of a communication failure occurs in the frequency band of the channel 3 during this time zone.

[Environment Measuring Section 202]

Explanation of the wireless transmitting and receiving device 20 is continued with reference to FIG. 2 again.

The environment measuring section 202 associates the measurement result data outputted by the sensor 30 with time, and stores this association. The sensor 30 measures an element that causes a communication failure, and outputs the measurement result data to the environment measuring section 202. The following examples are the elements causing a communication failure: (1) noise; (2) temperature; (3) humidity; and (4) dew condensation.

As the sensor 30 that measures these elements causing a communication failure, the wireless transmitting and receiving device 20 according to the present embodiment has four types of sensors 30, i.e., a noise measuring device, a temperature sensor, a humidity sensor, and a dew condensation sensor. It should be noted that these sensors 30 are provided within a communication range of the wireless transmitting and receiving device 20, which is a connection destination.

Hereinafter, the elements (1) through (4) that cause a communication failure are described.

Noise is preferably measured for each frequency band used by the wireless transmitting and receiving device 20. The causes that raise the noise are, in the case of, for example, a 13.56-MHz band, noise that is generated from an electric installation having an inverter through a power supply line or sky-wave propagation, noise that is generated from electronic devices such as a personal computer, and radio waves of shortwave broadcasting. In a 950-MHz band, the causes may be noise from industrial wireless transmission, and noise from devices related to cellular phones. Moreover, in the case in which the wireless transmitting and receiving devices 20 using the same frequency band are installed adjacent to each other, or in the case in which the same type of readers and writers, access points or the like are installed in adjacent rooms or buildings, the radio waves are generated by these wireless transmitting and receiving devices 20, causing a communication failure.

Temperature, humidity and dew condensation may affect a communication environment significantly, causing a communication failure. Particularly in the case of a wireless communication transmitting and receiving device 20 using a 2.45-G band, humidity affects the communication environment thereof significantly.

FIG. 4 shows an example of the measurement result data stored in the environment measuring section 202. Measurement result data 400 shown in FIG. 4 generates one record 401 every unit of time (one second in this example). The measurement result data 400 is configured by the record 401 that is added every time as time advances. Each record 401 is constituted by a time field 402, and fields 403 through 406 that store measurement results obtained from the sensors 30 respectively. In this example, the environment measuring section 202 receives measurement results from the four sensors 30, and stores the measurement results in the corresponding fields. The four sensors 30 are a noise level sensor, a temperature sensor, a humidity sensor, and a dew condensation sensor. The measurement results of these four sensors 30 are stored in the noise field 403, temperature field 404, humidity field 405, and dew condensation field 406 respectively.

It should be noted that FIG. 1 and FIG. 2 show these sensors 30 as the devices separated from the wireless transmitting and receiving device 20 and connected to the wireless transmitting and receiving device 20 via communication cables or the like. However, the sensors 30 may be configured to be installed within the wireless transmitting and receiving device 20.

[Log Generating Section 203]

Explanation of the wireless transmitting and receiving device 20 is continued with reference to FIG. 2 again.

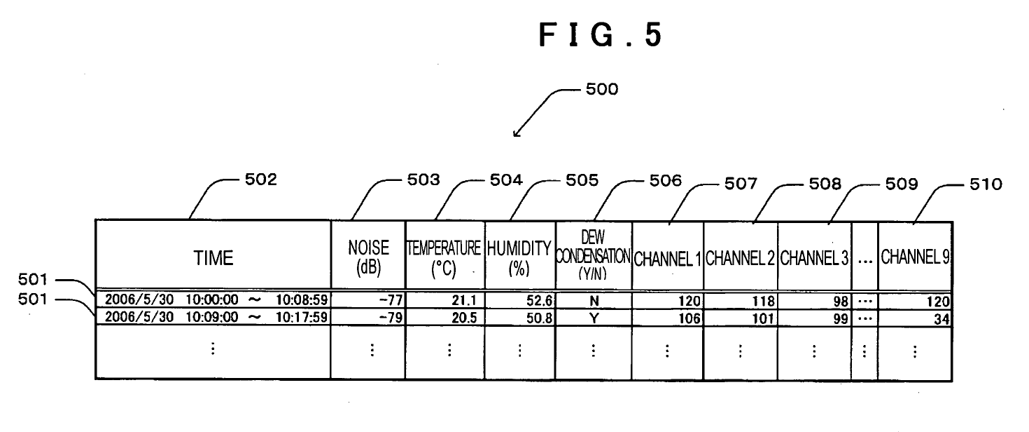

The log generating section 203, one of the components of the wireless transmitting and receiving device 20, generates a log on the basis of the communication execution report 300 outputted from the wireless transmitting and receiving device 201 and the measurement result data 400 outputted from the environment measuring section 202, and transmits the log to the wireless communication failure monitoring device 40. FIG. 5 shows an example of the log generated by the log generating section 203. A log 500 has one record 501 for each time (including a time zone), and each record 501 has a time field 502 for storing a time zone of the record 501, a noise field 503 for storing a measurement result included in the measurement result data, a temperature field 504, a humidity field 505, and a dew condensation field 506, and further has a channel 1 field 507, a channel 2 field 508, a channel 3 field 509 and a channel 9 field 510 for storing a response situation for each channel (a channel 4 field through a channel 8 field are omitted).

In the example shown in FIG. 5, a first record 501 (the top record in the figure) stores a measurement result and a response situation of each channel in a time zone between “10:00:00” and “10:08:59” on a date “2006/5/30”.

The log generating section 203 adds the record 501 for every time zone to generate the log 500. The log generating section 203 outputs the generated log 500 to the wireless communication failure monitoring device 40 at appropriate time.

[Wireless Communication Failure Monitoring Device 40]

Explanation of the wireless communication failure monitoring device 40 is continued with reference to FIG. 1 again.

The wireless communication failure monitoring device 40 receives the log 500 from the wireless transmitting and receiving device 20, and monitors the presence or absence of the occurrence of a communication failure in the communication range of the wireless transmitting and receiving device 20 on the basis of the log 500.

The wireless communication failure monitoring device 40 is provided with a central processing unit (CPU), main memory (RAM), read-only memory (ROM), an input and output device (I/O), and, according to need, an external storage device such as a hard disk device, and is an information processing device such as a computer or a work station. A program for causing the information processing device to function as the wireless communication failure monitoring device 40, or a program for causing the computer to execute a communication failure monitoring method is stored in the ROM or the hard disk device. Such a program is mounted on the main memory, and the CPU executes this program, whereby the wireless communication failure monitoring device 40 is realized or the communication state monitoring method is executed. Furthermore, the abovementioned program is not necessarily stored in the storage device within the information processing device, and thus may be provided from an external device (e.g., ASP (a server of application service provider)) and mounted on the main memory.

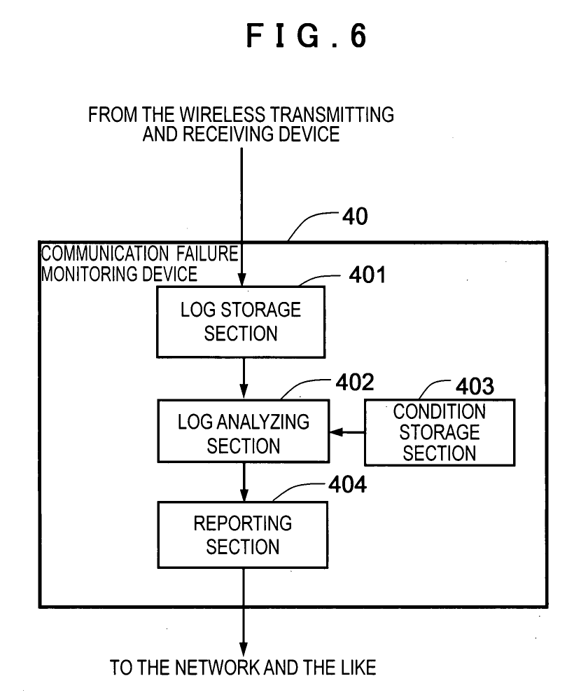

FIG. 6 is a functional block diagram showing a configuration example of the wireless communication failure monitoring device 40.

The wireless communication failure monitoring device 40 shown in FIG. 6 has a log storage section 401, a log analyzing section 402 that references contents stored in the log storage section 401, a condition storage section 403 that is referenced by the log analyzing section 402, and a reporting section 404 that receives a command from the log analyzing section 402 and executes predetermined reporting processing in response to the command.

The log storage section 401 has a function of storing the log 500 transmitted from each wireless transmitting and receiving device 20. The log storage section 401 stores one log 500 for each wireless transmitting and receiving device 20. The wireless communication failure monitoring device 40 analyzes each log 500, and thereby can know the presence or absence of the occurrence of a communication failure within the communication range of each wireless transmitting and receiving device 20. Also, by analyzing past logs 500 that are accumulated and stored, the wireless communication failure monitoring device 40 can know what kind of environmental condition causes a communication failure.

The log analyzing section 402 has a function of analyzing the log 500 and thereby determining the presence or absence of the occurrence of a communication failure within the communication range of the wireless transmitting and receiving device 20. In this determination, conditions stored in the condition storage section 403 are used, the conditions being described hereinafter. As a result of the determination, if it is determined that the occurrence of a communication failure is present, the log analyzing section 402 sends to the reporting section 404 a command to report the occurrence of a communication failure, the reporting section 404 being described hereinafter.

The condition storage section 403 stores conditions of causing the reporting section 404 to execute the predetermined reporting processing, i.e., conditions of recognizing the occurrence of a communication failure. For example, the condition storage section 403 stores such conditions that the temperature is at least X° C., the temperature is at least Y %, and the response situation is 50% or less compared to other channels. A plurality of conditions may be stored. The contents of the conditions may be determined based on the past operational experiences, or may be determined by the performance or use of the terminal device 10 and wireless transmitting and receiving device 20. Furthermore, the conditions may be set by the manager or the like on the basis of these contents.

Once receiving a command from the log analyzing section 402, the reporting section 404 performs the reporting processing for notifying a predetermined report destination of the occurrence of a communication failure. Specific methods of the reporting processing are, for example, methods of transmitting an e-mail to the manager of the system, displaying a failure occurrence message on a monitoring site, and the like, but there are no restrictions on the reporting methods.

It should be noted that in the case of the wireless communication failure monitoring system 1 having a plurality of wireless transmitting and receiving devices 20, the reporting section 404 may include, in the report, information indicating in which wireless transmitting and receiving device 20 a communication failure occurs, such as an identification number of the wireless transmitting and receiving device 20 and a location in which the wireless transmitting and receiving device 20 is installed (e.g., a floor number, room number, section number, division name, etc.).

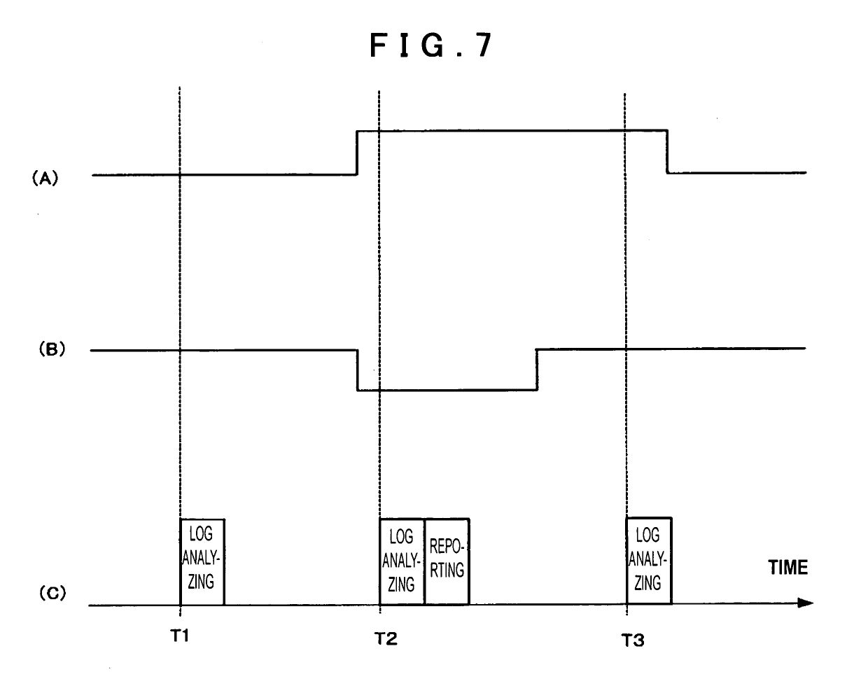

FIG. 7 is a timing chart showing an example of operation of the wireless communication failure monitoring device 40. (A) of FIG. 7 shows a change in the element causing a communication failure, the element being outputted from a certain sensor 30, (B) of FIG. 7 shows a change in the communication situation outputted from the wireless communication section 201, and (C) of FIG. 7 shows operation of the wireless communication failure monitoring device 40. In this example, if the element causing a communication failure and the communication situation both show values indicating an abnormality, the conditions stored in the condition storage section 403 are satisfied.

At time T1, the element causing a communication failure and the communication situation are normal. Therefore, at the time T1, the wireless communication failure monitoring device 40 performs log analyzing processing, but does not perform the reporting processing because the conditions stored in the condition storage section 403 are not satisfied. Then, at time T2, the element causing a communication failure and the communication situation both are changed to the values indicating an abnormality. Once the wireless communication failure monitoring device 40 performs the log analyzing processing, the conditions stored in the condition storage section 403, which indicate that the element causing a communication failure and the communication situation both are changed to the values indicating an abnormality, are satisfied, thus the wireless communication failure monitoring device 40 performs the reporting processing. By means of this reporting processing, the report destination can be notified, in real time, of that a communication failure occurs.

Then, at time T3, the element causing a communication failure is changed to a value indicating an abnormality, while the value indicating the communication situation is normal. Therefore, although the wireless communication failure monitoring device 40 performs the log analyzing processing at the time T3, the wireless communication failure monitoring device 40 does not perform the reporting processing since the conditions stored in the condition storage section 403 are not satisfied.

Moreover, by analyzing the accumulated logs, further specific causes of the communication failure (elements, a combination of the elements, values, etc.) can be identified.

[Advantage]

According to the present system, the manager can know when, where and why the problem causing a communication failure is generated, and the manager can also automatically obtain information indicating whether the communication failure occurs continuously, periodically, or irregularly. As a result, the manager can realize a stable and highly reliable system operation.

[Modifications]

(1) Although FIG. 1 shows a configuration of one wireless transmitting and receiving device 20, the wireless communication failure monitoring system 1 according to the present embodiment is established even if not only one wireless transmitting and receiving device 20 but also a plurality of wireless transmitting and receiving devices 20 are connected to one wireless communication failure monitoring device 40. For example, in a business institution constituted by a plurality of floors, an access point functioning as one wireless transmitting and receiving device 20 is provided in each floor, and these access points are connected to a computer functioning as the wireless communication failure monitoring device 40, whereby the wireless communication failure monitoring system 1 is configured.

(2) In the above embodiment, although the occurrence of a communication failure is determined based on the element causing a communication failure, that can be detected by the sensor 30, and the communication execution report, the occurrence of a communication failure may be determined based on only the communication execution report. For example, a communication situation between the terminal device 10 and the wireless transmitting and receiving device 20 can be affected by newly installing a desk, partition, shelf and the like to be placed in a room, or by moving from place to place. In such a case, although the measurement result data obtained from the sensor 30 may not show any changes, the communication execution report shows the occurrence of a communication failure. The examples of the occurrence of a communication failure are the increase in the frequency of shifting to other channel and the decrease in the communication speed rate in the wireless transmitting and receiving device 20 having an LBT (Listen Before Talk) function, which is a type of a radio interference technology in wireless communication. In the case in which the log analyzing section 402 detects such changes from the logs, the log analyzing section 402 issues a command to the reporting section 404 and causes it to issue a report, even if the measurement result data of the sensor 30 does not show any changes.

As described above, according to the first embodiment, the occurrence of a communication failure can be reported to the manager or the like in a state in which the situation of specific problems of the failure (possible causes) can be identified. Therefore, the manager who receives the report can perform more stable and highly reliable system operation using wireless communication.

### Second Embodiment

Next, the wireless communication failure monitoring system according to a second embodiment of the present invention is described.

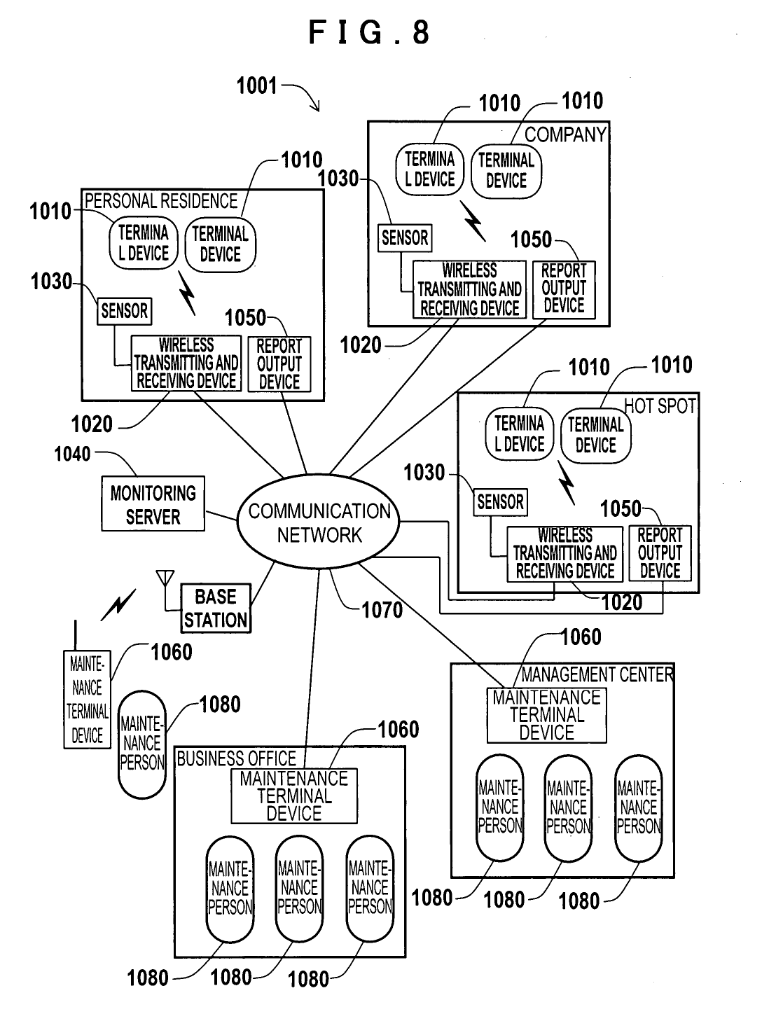

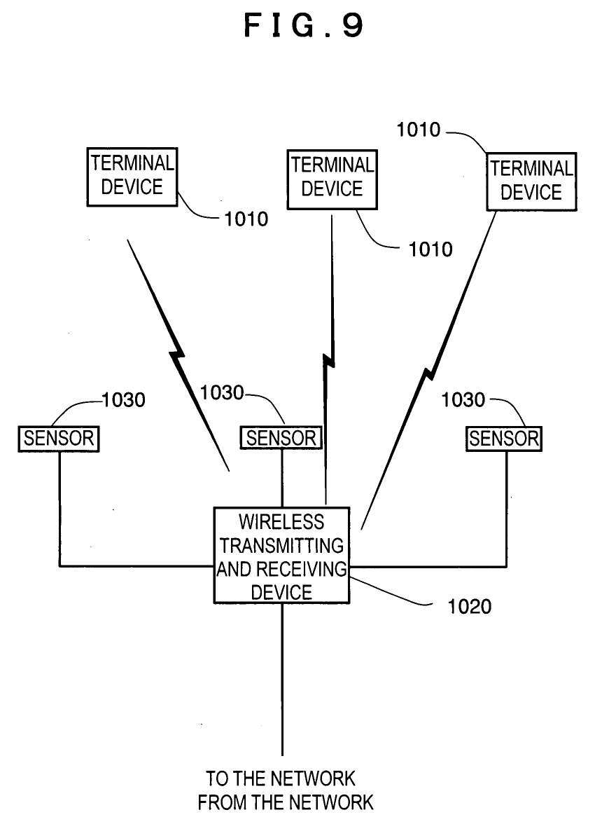

This wireless communication failure monitoring system is configured as a maintenance system. FIG. 8 is a block diagram showing a configuration example thereof, and FIG. 9 is a block diagram showing a part of the maintenance system, and is also an enlarged block diagram showing sections centered around the wireless transmitting and receiving device. It should be noted that the basic configurations of the system are the same as those described in the first embodiment, thus the members having the same functions are expressed in reference numerals obtained by adding 1000 to the reference numerals shown in the first embodiment, and thus the detailed descriptions thereof are omitted.

Hereinafter, the maintenance system according to the second embodiment is described with reference to FIG. 8 and FIG. 9. The “maintenance system” herein is a system in which at least some of data transmission channels are wireless (a system maintained by the present maintenance system; referred to as “maintenance target system”), wherein the occurrence of a communication failure is detected in the wireless transmission channels, and predetermined processing is executed in order to fix the communication failure.

This maintenance system 1001 has: a terminal device 1010; a wireless transmitting and receiving device 1020 that wirelessly performs data transmission with the terminal device 1010, the wireless transmitting and receiving device 1020 having one or a plurality of types of sensors that measure an element changing a communication environment (referred to as “communication environment variation element” hereinafter) in a wireless transmission channel between the terminal device 1010 and the wireless transmitting and receiving device 1020; a monitoring server 1040 that receives, from the wireless transmitting and receiving device 1020, a communication execution situation between the wireless transmitting and receiving device 1020 and the terminal device 1010 and a result of measurement of the communication environment variation element measured by the sensor 1030, monitors the occurrence of a communication failure on the basis of the received communication execution situation and measurement result, and executes predetermined processing for perform maintenance on the basis of a monitor result; a report output device 1050 that shows a user a report having an advise for fixing the communication failure; and a maintenance terminal device 1060 that outputs a message or the like for sending a maintenance person 1080 (a service engineer, a maintenance man, etc.) to a location in which the communication failure occurs.

The wireless transmitting and receiving device 1020, terminal device 1010 and report output device 1050 may be installed and used in any locations. These devices may be used in, for example, a personal residence, a company, a public hot spot, or the like. Furthermore, the maintenance terminal device 1060 may be provided in a management center or a business office of a maintenance service company and a maintenance company, or a mobile communication terminal carried by the maintenance person 1080 may be taken as the maintenance terminal device 1060.

The monitoring server 1040 can communicate with the wireless transmitting and receiving device 1020, report output device 1050 and maintenance terminal device 1060 via a communication network 1070.

[Terminal Device 1010]

The terminal device 1010 is a device that performs data transmission wirelessly with the wireless transmitting and receiving device 1020. The terminal device 1010 is, for example, a personal computer having a function that can be connected to a wireless IC tag or wireless LAN, a wireless IP telephone terminal (a wireless SIP phone, for example), a domestic electric device that can be controlled by a wireless LAN (a network television, a refrigerator, etc.) and the like.

[Wireless Transmitting and Receiving Device 1020]

The wireless transmitting and receiving device 1020 exchanges data with the terminal device 1010 by means of wireless transmission, and, according to need, transmits data received from the terminal device 1010 to a main device or network, or transmits data received from the main device or network to the terminal device 1010.

Also, the wireless transmitting and receiving device 1020 transmits, via the communication network to the monitoring server 1040, a log, which is data configured by a communication execution report and measurement result data, the communication execution report being a report on an execution state of the data transmission performed between the wireless transmitting and receiving device 1020 and the terminal device 1010, and the measurement result data being a result of measurement detected by the sensor 1030.

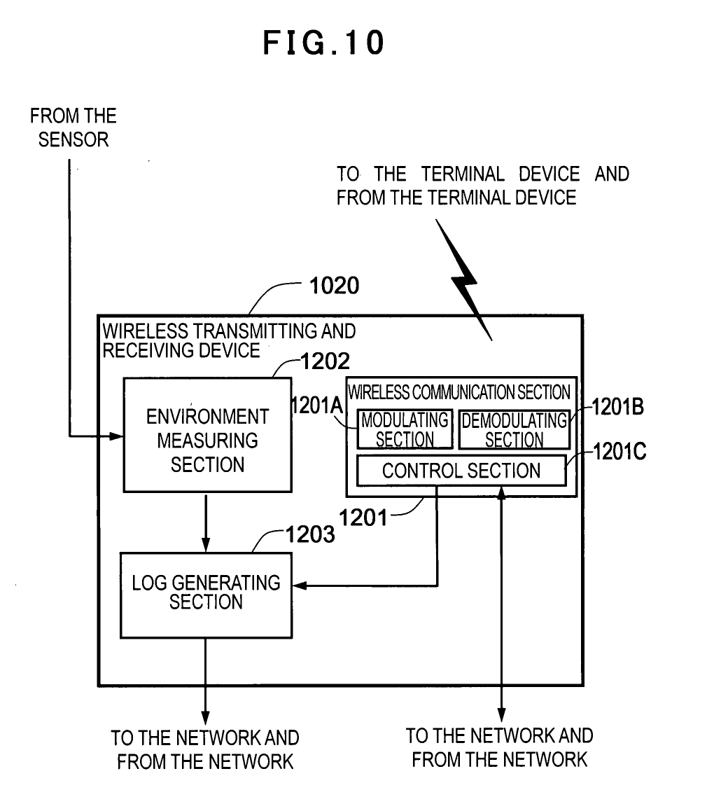

FIG. 10 is a block diagram showing a configuration example of the wireless transmitting and receiving device 1020. The wireless transmitting and receiving device 1020 has a wireless communication section 1201 that exchange data with the terminal device 1010 by means of wireless transmission, an environment measuring section 1202 that receives the measurement result data from the sensor 1030 and stores this data every time, and a log generating section 1203 that receives a communication execution report from the wireless communication section 1201, receives the measurement result data from the environment measuring section 1202, generates a log on the basis of the received report and data, and transmits the generated log to the monitoring server 1040.

[Wireless Communication Section 1201]

The wireless communication section 1201 modulates transmission data and demodulates received data to exchange data with the terminal device 1010 by means of wireless transmission. Furthermore, the wireless communication section 1201 outputs the communication execution report, which is data indicating the execution state of the communication performed between the wireless communication section 1201 and the terminal device 1010. For example, the wireless communication section 1201 outputs, as the communication execution report, time at which a call is sent to the terminal device 1010, a situation in which a response is received from the terminal device 1010 as a result of the call.

The wireless communication section 1201 has a modulating section 1201A that transmits data on a carrier wave by means of a predetermined modulation method, a demodulating section 1201B that demodulates an electric wave received from the terminal device, by means of a predetermined demodulation method, and a control section 1201C that controls the operations of the modulating section 1201A and the demodulating section 1201B. The control section 1201C can autonomously control the operations of the modulating section 1201A and the demodulating section 1201B by means of a program that is pre-installed, and can also control the operations of the modulating section 1201A and the demodulating section 1201B in response to a command sent from the monitoring server 1040. For example, the control section 1201C switches a working frequency to a predetermined channel in response to a use channel switching command from an LBT (Listen Before Talk) function, which is a type of a radio interference prevention technology in wireless communication and the like, previously removes the channel in which a communication failure is predicted to occur, from frequency hopping target channels in accordance with the circumstances of a floor noise, and references a floor noise value so that the LBT function and frequency hopping are operated optimally.

Moreover, in the case in which a plurality of different frequency bands (channels) can be used in data transmission, the wireless communication section 1201, more particularly the control section 1201C, includes, in the communication execution report, a situation in which the frequency bands are switched, a call sent to each terminal device 1010 in each frequency band, time at which the call is sent, and a situation in which a response is received from the terminal device 1010 as a result of the call, and outputs this communication execution report to the log generating section 1203 described hereinafter.

It should be noted that the explanation of the communication execution report outputted from the wireless communication section 1201 is the same as that of the first embodiment (see FIG. 3).

[Environment Measuring Section 1202]

Also, the explanation of the wireless transmitting and receiving device 1020, which is provided with reference to FIG. 3, is similarly applied to the second embodiment.

Also, the explanations of the elements (1) through (4) causing the communication failure are also the same as those of the first embodiment.

Furthermore, the above explanations that are provided with reference to FIG. 4 and FIG. 5 are applied similarly to the second embodiment.

It should be noted that FIG. 9 and FIG. 10 show the sensors 1030 as the devices separated from the wireless transmitting and receiving device 1020 and connected to the wireless transmitting and receiving device 1020 via communication cables or the like. However, the sensors 1030 may be configured to be installed within the wireless transmitting and receiving device 1020.

[Monitoring Server 1040]

Explanation of the monitoring server 1040 is continued with reference to FIG. 8 again.

The monitoring server 1040 receives a log 500 from the wireless transmitting and receiving device 1020, monitors the presence or absence of the occurrence of a communication failure in the communication range of the wireless transmitting and receiving device 1020 on the basis of the log 500, and executes predetermined processing for responding to the communication failure.

The monitoring server 1040 is provided with a central processing unit (CPU), main memory (RAM), read-only memory (ROM), an input and output device (I/O), and, according to need, an external storage device such as a hard disk device, and is an information processing device such as a computer or a work station. A program for causing the information processing device to function as the monitoring server 1040, or a program for causing the computer to execute a maintenance service providing method is stored in the ROM or the hard disk device. Such a program is mounted on the main memory, and the CPU executes this program, whereby the monitoring server 1040 is realized or the maintenance service providing method is executed. Furthermore, the abovementioned program is not necessarily stored in the storage device within the information processing device, and thus may be provided from an external device (e.g., ASP (a server of application service provider)) and mounted on the main memory.

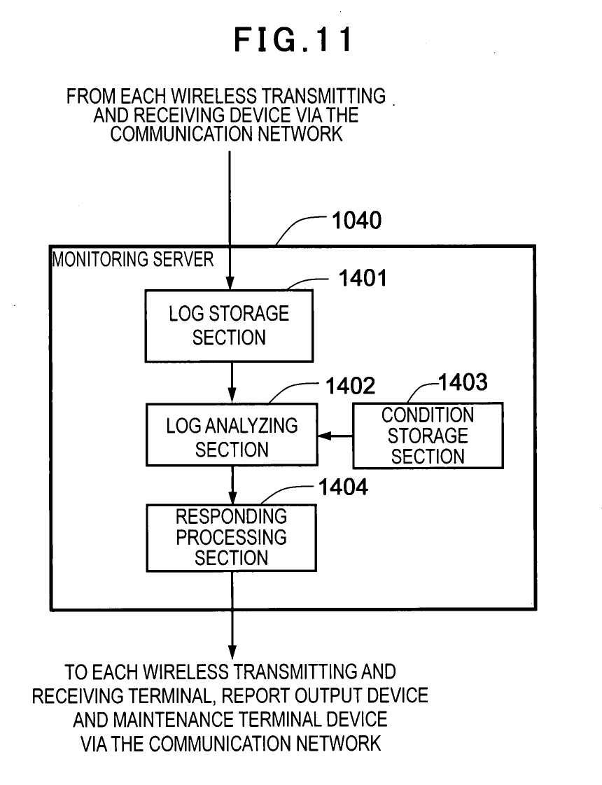

FIG. 11 is a functional block diagram showing a configuration example of the monitoring server 1040.

The monitoring server 1040 shown in FIG. 11 has a log storage section 1401, a log analyzing section 1402 that references contents stored in the log storage section 1401, a condition storage section 1403 that is referenced by the log analyzing section 1402, and a responding processing section 1404 that receives a command from the log analyzing section 1402 and executes predetermined processing in response to the command in order to fix the communication failure.

The log storage section 1401 has a function of storing the log 500 transmitted from each wireless transmitting and receiving device 1020. The log storage section 1401 stores one log 500 for each wireless transmitting and receiving device 1020. The monitoring server 1040 analyzes each log 500, and thereby can know the presence or absence of the occurrence of a communication failure within the communication range of each wireless transmitting and receiving device 1020. Also, by analyzing past logs 500 that are accumulated and stored, the monitoring server 1040 can know what kind of environmental condition causes a communication failure.

The log analyzing section 1402 has a function of analyzing the log 500 and thereby determining the presence or absence of the occurrence of a communication failure within the communication range of the wireless transmitting and receiving device 1020. In this determination, conditions stored in the condition storage section 1403 are used, the conditions being described hereinafter. As a result of the determination, if it is determined that the occurrence of a communication failure is present, the log analyzing section 1402 sends to the responding processing section 1404 a command to execute the predetermined processing for fixing the communication failure.

The condition storage section 1403 stores conditions of causing the responding processing section 1404 to execute the predetermined processing, i.e., conditions of recognizing the occurrence of a communication failure. For example, the condition storage section 1403 stores such conditions that the temperature is at least X° C., the temperature is at least Y %, and the response situation is 50% or less compared to other channels. A plurality of conditions may be stored. The contents of the conditions may be determined based on the past operational experiences, or may be determined by the performance or use of the terminal device 1010 and wireless transmitting and receiving device 1020. Furthermore, the conditions may be set by the manager or the like on the basis of these contents.

Once the responding processing section 1404 receives the command from the log analyzing section 1402, the responding processing section 1404 executes the predetermined processing (referred to as “maintenance responding processing” hereinafter) for fixing the communication failure.

<Maintenance Responding Processing>

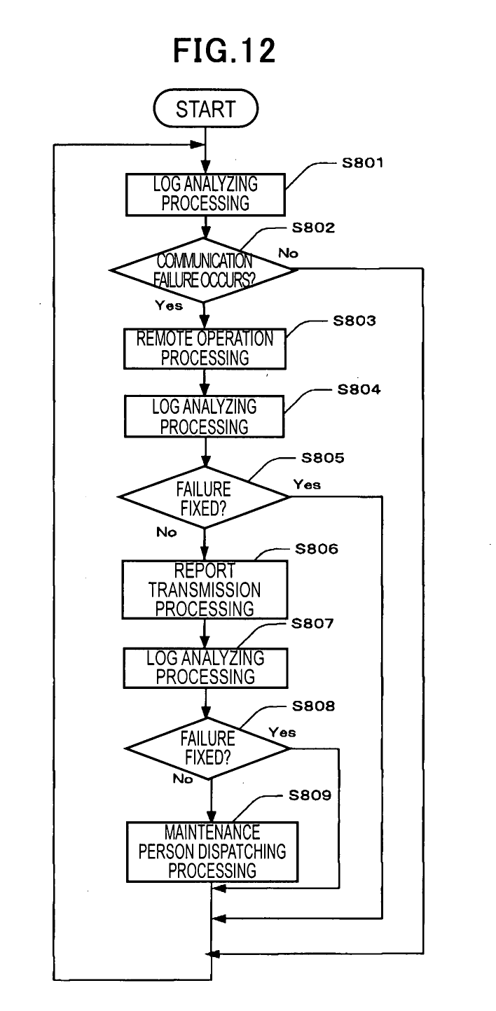

FIG. 12 is a flowchart showing an example of the maintenance responding processing. Hereinafter, an example of the maintenance responding processing is described with reference to FIG. 12.

First, the monitoring server 1040, more particularly the responding processing section 1404, performs log analyzing processing for analyzing the log received from the wireless transmitting and receiving device 1020 and determining the presence or absence of the occurrence of a communication failure (S801). It should be noted in this embodiment that the maintenance responding processing is performed for each log. Specifically, the presence or absence of the occurrence of a communication failure is determined for each wireless transmitting and receiving device 1020, and the predetermined processing is performed on the basis of the result of the determination.

In the case in which it is determined in the log analyzing processing that the occurrence of a communication failure is absent (S802, No), the monitoring server 1040, more particularly the responding processing section 1404, ends the maintenance responding processing and waits to execute the next maintenance responding processing.

On the other hand, in the case in which it is determined in the log analyzing processing that the occurrence of a communication failure is present (S802, Yes), the monitoring server 1040, more particularly the responding processing section 1404, performs remote operation processing in order to cause the wireless transmitting and receiving device 1020 to perform adjustment to fix the communication failure (S803). For example, in the case in which the logs 500 indicate that the noise level of a certain channel is increased abnormally, the monitoring server 1040, more particularly the responding processing section 1404, transmits a command to the wireless transmitting and receiving device 1020 to cause it to stop using the channel and to perform communication using other channel. Alternatively, in the case in which the logs 500 indicate that carrier sense cannot be performed normally due to the increase of the noise level around the wireless transmitting and receiving device 1020, the responding processing section 1404 transmits a command to the wireless transmitting and receiving device 1020 to cause it to adjust a threshold level to be recognized as carrier reception.

Next, the monitoring server 1040, more particularly the responding processing section 1404, performs the log analyzing processing for analyzing the log 500 received from the wireless transmitting and receiving device 1020, after a lapse of a predetermined period of time, and determining fixing of the communication failure (S804). The log 500 to be analyzed in S804 is newer than the log analyzed in S801. When it is determined in this log analyzing processing (S804) that the communication failure is fixed (S805, Yes), the monitoring server 1040, more particularly the responding processing 1404, ends the maintenance responding processing and waits to execute the next maintenance responding processing.

When, on the other hand, it is determined in the log analyzing processing that the communication failure is not fixed (S805, No), the monitoring server 1040, more particularly the responding processing section 1404, performs report transmission processing, which is the processing for transmitting a report for fixing the communication failure to the report output device 1050 corresponding to the wireless transmitting and receiving device 1020 (S806). This report is information for notifying a predetermined person such as an owner or manager of the wireless transmitting and receiving device 1020 of a situation where the communication failure occurs (time zone of the occurrence, repeated interval, etc.), and possible causes of the communication failure. This report is automatically generated by a program on the basis of the log 500. The report output device 1050 outputs this report in a manner that the owner or manager of the wireless transmitting and receiving device 1020 can recognize. This report may be outputted to the owner or manager of the wireless transmitting and receiving device 1020 by means of any medium and method. It is considered that the report be outputted using a printed material (including a fax), an e-mail, a web site, an electronic bulletin board, or the like.

Next, the monitoring server 1040, more particularly the responding processing section 1404, performs the log analyzing processing for analyzing the log 500 received from the wireless transmitting and receiving device 1020, after a lapse of a predetermined period of time, and determining fixing of the communication failure (S807). The log 500 to be analyzed in S807 is newer than the log analyzed in S804. When it is determined in this log analyzing processing (S807) that the communication failure is fixed (S808, Yes), the monitoring server 1040, more particularly the responding processing 1404, ends the maintenance responding processing and waits to execute the next maintenance responding processing.

When, on the other hand, it is determined in the log analyzing processing (S807) that the communication failure is not fixed (S808, No), the monitoring server 1040, more particularly the responding processing section 1404, performs maintenance person dispatching processing (S809) for sending the maintenance person 1080 to fix the communication failure in the wireless transmitting and receiving device 1020. The maintenance person dispatching processing is the processing for transmitting a command to the maintenance terminal device 1060 and causes it to send the maintenance person to fix the communication failure occurring in the wireless transmitting and receiving device 1020. It should be noted that the present maintenance system 1001 is generally provided with a plurality of maintenance terminal devices 1060. For example, each maintenance terminal device 1060 is provided in a main management center, a business office in each district, a service center, and the like. In the maintenance person dispatching processing, the monitoring server 1040, more particularly the responding processing section 1404, selects a maintenance person who is in the best location to go to the wireless transmitting and receiving device 1020 to fix the communication failure thereof, or who satisfies other conditions, and then sends a command to the maintenance person 1080.

The maintenance responding processing is ended in the manner described above.

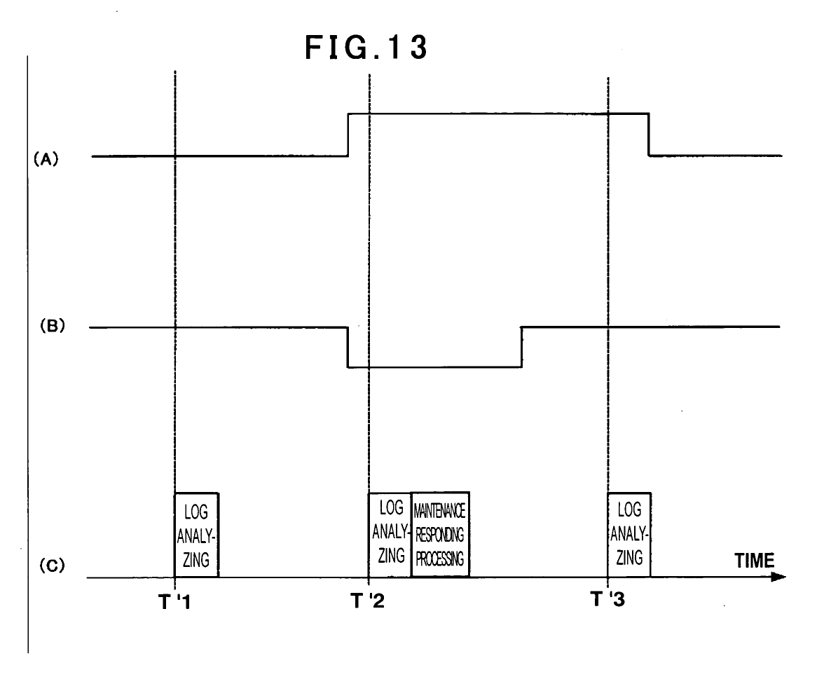

FIG. 13 is a timing chart showing an example of operation of the monitoring server 1040. (A) of FIG. 13 shows a change in the element causing a communication failure, the element being outputted from a certain sensor 1030, (B) of FIG. 13 shows a change in the communication situation outputted from the wireless communication section 1201, and (C) of FIG. 13 shows operation of the monitoring server 1040. In this example, if the element causing a communication failure and the communication situation both show values indicating an abnormality, the conditions stored in the condition storage section 1403 are satisfied.

At time T′ 1, the element causing a communication failure and the communication situation are normal. Therefore, at the time T′1, the monitoring server 1040 performs log analyzing processing, but does not perform the maintenance responding processing because the conditions stored in the condition storage section 1403 are not satisfied. Then, at time T′2, the element causing a communication failure and the communication situation both are changed to the values indicating an abnormality. Once the monitoring device 1040 performs the log analyzing processing, the conditions stored in the condition storage section 1403, which indicate that the element causing a communication failure and the communication situation both are changed to the values indicating an abnormality, are satisfied, thus the monitoring device 1040 performs the maintenance responding processing.

Then, at time T′3, the element causing a communication failure is changed to a value indicating an abnormality, while the value indicating the communication situation is normal. Therefore, although the monitoring server 1040 performs the log analyzing processing at the time T′3, the monitoring device 1040 does not perform the maintenance responding processing since the conditions stored in the condition storage section 1403 are not satisfied.

Moreover, by analyzing the accumulated logs, further specific causes of the communication failure (elements, a combination of the elements, values, etc.) can be specified.

<Report Transmission Processing in the Maintenance Responding Processing>

[Report Output Device 1050]

The report output device 1050 is a device that outputs a report transmitted from the monitoring server 1040, by means of the execution of report transmission processing (S806), which is a part of the maintenance responding processing. The report output device 1050 can be various devices depending on the output medium for outputting the report. If wishing to receive the report as a printed material, a facsimile device serves as the report output device 1050. If wishing to receive the report as an e-mail, a computer equipped with electronic mail software serves as the report output device 1050. If wishing to receive (view) the report as a web site or electronic bulletin board, a computer equipped with a web browser serves as the report output device 1050. The report output device 1050 may be a mobile communication terminal such as a cellular phone or PDA.

<Maintenance Person Dispatching Processing>

[Maintenance Terminal Device 1060]

The maintenance terminal device 1060 is a device that outputs a maintenance request message transmitted from the monitoring server 1040, by means of the execution of the maintenance person dispatching processing (S809), which is a part of the maintenance responding processing. The maintenance terminal device 1060 can be various devices depending on the output medium for outputting the report. If wishing to receive the report as a printed material, a facsimile device serves as the maintenance terminal device 1060. If wishing to receive the report as an e-mail, a computer equipped with electronic mail software serves as the maintenance terminal device 1060. If wishing to receive (view) the report as a web site or electronic bulletin board, a computer equipped with a web browser serves as the maintenance terminal device 1060. The maintenance terminal device 1060 may be a mobile communication terminal such as a cellular phone or PDA.

[Communication Network 1070]

When each of devices connected to the communication network 1070 establishes a session with a device that each of these devices destines, the devices being connected via a wire or wirelessly, dedicated line, or switched line, the communication network 1070 operates such that information can be transmitted between these devices. The communication network 1070 may be realized by combining a plurality of networks via gateways, as can be see in the Internet. Also, these networks may not be connected directly to a principal line called “backbone” but may be connected temporarily as with PPP connection, or any connection is possible as long as information can be transmitted between the devices when the sessions are established. It should be noted that the “communication network” described above includes a connection in which no switching systems are used, such as a communication network in which dedicated lines are extended fixedly. Furthermore, the “communication network” described above may be subjected to predetermined encryption processing as a security measure.

<Maintenance System Sequence>

[Operation of the Maintenance System]

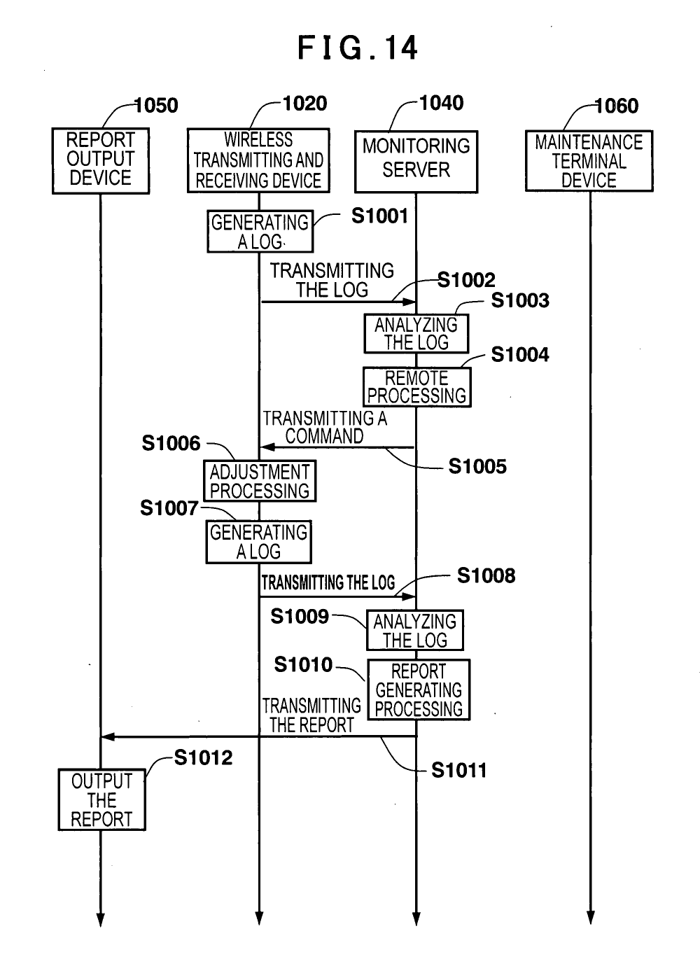

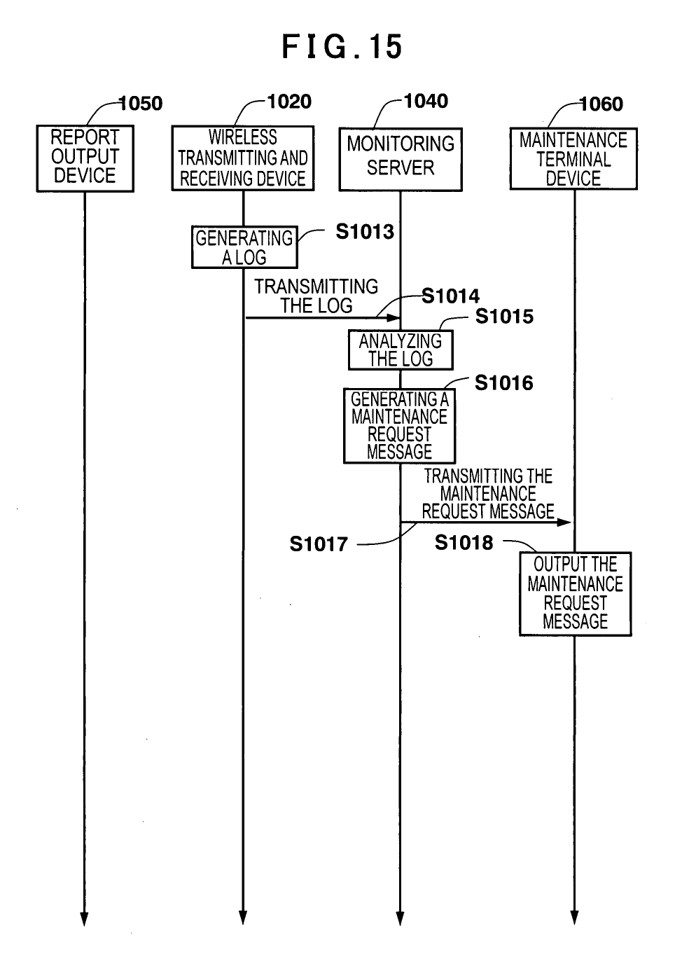

Next, an example of operation of the present maintenance system 1001 is described with reference to FIG. 14 and FIG. 15. FIG. 14 is a sequence diagram showing an example of operation of the present maintenance system 1001, and FIG. 15 is a sequence diagram showing an example of the operation subsequent to FIG. 14.

First, the wireless transmitting and receiving device 1020 performs log generation (S1001). It should be noted that the measurement result data obtained from the sensor 1030 and the communication execution report of the wireless communication section 1201 are generated prior to the log generation. The wireless transmitting and receiving device 1020 transmits the generated log to the monitoring server 1040 via the communication network 1070 (S1002). The monitoring server 1040 that receives the log stores the log in the log storage section 1401, and performs the log analyzing processing for analyzing this log at predetermined time (S1003).

When it is determined in this log analyzing processing that a communication failure occurs, the monitoring server 1040, more particularly the responding processing section 1404, performs the remote operation processing so as to cause the wireless transmitting and receiving device 1020 to perform adjustment to fix the communication failure (S1004), and transmits a command to this wireless transmitting and receiving device 1020 (S1005). The wireless transmitting and receiving device 1020 that receives the command, more particularly the control section 1201C, executes adjustment processing corresponding to the content of the command (S1006), to attempt to fix and avoid the communication failure.

This wireless transmitting and receiving device 1020 executes log generation in order to generate a new log 500 at predetermined time (S1007). Then, the wireless transmitting and receiving device 1020 transmits the generated new log to the monitor server 1040 via the communication network 1070 (S1008). In this new log 500 the result of the adjustment processing (S1006) performed previously is reflected. Specifically, by analyzing this new log 500, it is determined whether the communication failure is fixed and avoided successfully or not by the adjustment processing.

The monitoring server 1040 performs the log analyzing processing for analyzing the new log 500 and determined whether the communication failure is fixed and avoided successfully or unsuccessfully (S1009). When it is determined in this log analyzing processing that the communication failure is not fixed, the monitoring server 1040 generates a report for fixing the communication failure for the report output device 1050 corresponding to this wireless transmitting and receiving device 1020 (S1010), and transmits the generated report to the corresponding report output device 1050 (S1011).

The report output device 1050 that receives the report outputs this report (S1012), notifies the owner or manager of the corresponding wireless transmitting and receiving device 1020 of the occurrence of the communication failure, the cause of the occurrence, a method of fixing the failure and the like, and promotes a measure to deal with the communication failure. The owner or manager of the corresponding wireless transmitting and receiving device 1020 is expected to reference this report and take an appropriate response to remove the cause of the communication failure.

Next, this wireless transmitting and receiving device 1020 executes log generation in order to generate another new log 500 at predetermined time (S1013). In this new log 500, the result of the countermeasure performed by the owner or manager of the wireless transmitting and receiving device 1020 on the basis of the outputted report (see S1012) is reflected. Specifically, the monitoring server 1040 further analyzes this new log 500, whereby it is determined whether or not the communication failure is fixed and avoided successfully by the owner or manager of the wireless transmitting and receiving device 1020.

The wireless transmitting and receiving device 1020 transmits this new log 500 to the monitoring server 1040 (S1014).

The monitoring server 1040 performs the log analyzing processing for analyzing this new log 500 received from the wireless transmitting and receiving device 1020, and determining fixing of the communication failure (S1015).

When it is determined in this log analyzing processing (S1015) that the communication failure is not fixed, the monitoring server 1040 performs the maintenance request message generating processing, which is the processing for sending the maintenance person 1080 to the wireless transmitting and receiving device 1020 to fix the communication failure thereof (S1017). Furthermore, the monitoring server 1040 selects and determines a maintenance terminal device 1060 that should receive the maintenance request message. Specifically, the monitoring server 1040 selects a maintenance terminal device 1060, which is in the best location to go to the wireless transmitting and receiving device 1020 to fix the communication failure thereof, or which satisfies other conditions, and then sends the maintenance request message (S1017).

The maintenance terminal device 1060 that receives the maintenance request message outputs this maintenance request message (S1018), and notifies the maintenance person 1080 of that there exists a wireless transmitting and receiving device 1020 that needs to have the communication failure fixed, the location where this wireless transmitting and receiving device 1020 is installed, the matter that is considered to be the cause of the communication failure, and the situation of the occurrence of the communication failure (time, time period, and the like). The maintenance person 1080 goes to the place where this wireless transmitting and receiving device 1020 is installed, in response to this maintenance request message, and performs a task required for fixing the communication failure (changing the settings of the wireless transmitting and receiving device 1020, improving the communication environment, etc.).

According to the present maintenance system 1001, in a system using wireless transmission, the occurrence of a communication failure in the wireless transmission, or the possibility of the occurrence is detected, and a countermeasure to fix the communication failure can be automatically taken on the basis of the detection result. As a result, in the case of using the system that uses the wireless transmission, the system can be promptly recovered from the communication failure, whereby the system can be prevented from being stopped as much as possible, and the reliability can be improved.

In the above embodiment, although the occurrence of a communication failure is determined based on the element causing a communication failure that can be detected by the sensor 1030 and the communication execution report, the occurrence of a communication failure may be determined based on only the communication execution report. For example, a communication situation between the terminal device 1010 and the wireless transmitting and receiving device 1020 can be affected by newly installing a desk, partition, shelf and the like to be placed in a room, or by moving from place to place. In such a case, although the measurement result data obtained from the sensor 1030 may not show any changes, the communication execution report shows the occurrence of a communication failure. The examples of the occurrence of a communication failure are the increase in the frequency of shifting to other channel and the decrease in the communication speed rate in the wireless transmitting and receiving device 1020 having the LBT (Listen Before Talk) function. In the case in which the log analyzing section 1402 detects such changes from the logs, the log analyzing section 1402 issues a command to the responding processing section 1404 and causes it to perform the maintenance responding processing, even if the measurement result data of the sensor 1030 does not show any changes.

As described above, according to the present embodiment, the occurrence of a communication failure can be automatically detected, and the communication failure can be automatically fixed by means of the remote processing, whereby the maintenance service for removing the communication failure can be provided promptly.

What is claimed is:

1. A wireless communication failure monitoring system, comprising:
a terminal device capable of transmitting and receiving data;
a wireless transmitting and receiving device that exchanges data with the terminal device and has a sensor for measuring a communication environment variation element that changes a communication environment in a wireless transmission channel between the terminal device and the wireless transmitting and receiving device; and
a monitoring device that receives, from the wireless transmitting and receiving device, a log that is generated on a basis of a communication execution report, which is data indicating an execution result of wireless communication performed between the terminal device and the wireless transmitting and receiving device, and on a basis of measurement result data indicating a result of measurement of the communication environment variation element outputted from the sensor, and determines an occurrence of a communication failure on the basis of the log.

2. The wireless communication failure monitoring system according to claim 1, wherein
the wireless transmitting and receiving device comprises: a wireless communication section that exchanges data with the terminal device;
an environment measuring section that receives the measurement result data from the sensor and stores the measurement result data every time; and a log generating section that receives a communication execution report from the wireless communication section, receives the measurement result data from the environment measuring section, generates a log on the basis of the received communication execution report and measurement result data, and transmits the generated log to the monitoring device.

3. The wireless communication failure monitoring system according to claim 1, wherein the terminal device is selected from at least one of a RFID (wireless IC tag), a wireless LAN personal computer, a wireless IP telephone terminal, and the like.

4. The wireless communication failure monitoring system according to claim 1, wherein the wireless transmitting and receiving device comprises at least one of a reader and writer, an access point, and the like.

5. The wireless communication failure monitoring system according to claim 1, wherein the sensor is at least one of a noise measuring device, temperature sensor, humidity sensor and dew condensation sensor.

6. The wireless communication failure monitoring system according to claim 1, wherein a plurality of wireless transmitting and receiving devices are connected to the monitoring device.

7. The wireless communication failure monitoring system according to claim 1, wherein the monitoring device comprises a monitoring section that receives, from the wireless transmitting and receiving device, a log that is generated on the basis of the communication execution report, which is data indicating an execution result of wireless communication performed between the terminal device and the wireless transmitting and receiving device, and the measurement result data indicating a result of measurement of the communication environment variation element outputted from the sensor, determines the occurrence of a communication failure on the basis of the log, and executes predetermined processing for dealing with the communication failure on the basis of a result of the determination.

8. The wireless communication failure monitoring system according to claim 7, wherein the predetermined processing is a remote operation processing for causing the wireless transmitting and receiving device to perform adjustment to fix the communication failure.

9. The wireless communication failure monitoring system according to claim 7, further comprising a report output device that reports the occurrence of a communication failure, wherein the predetermined processing is processing for transmitting, to the report output device corresponding to the wireless transmitting and receiving device, a report for fixing the communication failure.

10. The wireless communication failure monitoring system according to claim 7, further comprising a maintenance terminal device that displays a maintenance request message for sending a maintenance person to a location in which the wireless transmitting and receiving device having a communication failure is installed, wherein
the predetermined processing is processing for generating a maintenance request message for sending a maintenance person to a location in which the wireless transmitting and receiving device is installed, in order to fix the communication failure, and then transmitting the maintenance request message to the maintenance terminal device.

11. The wireless communication failure monitoring system according to claim 7, wherein the wireless transmitting and receiving device comprises: a wireless communication section that exchanges data with the terminal device; an environment measuring section that receives the measurement result data from the sensor and stores the measurement result data every time; and a log generating section that receives a communication execution report from the wireless communication section, receives the measurement result data from the environment measuring section, generates a log on the basis of the received communication execution report and measurement result data, and transmits the generated log to the monitoring device.

12. The wireless communication failure monitoring system according to claim 7, wherein the terminal device is selected from at least one of a RFID (wireless IC tag), a wireless LAN personal computer, a wireless LAN electrical apparatus, a wireless IP telephone terminal, and the like.

13. The wireless communication failure monitoring system according to claim 7, wherein the wireless transmitting and receiving device comprises at least one of a reader and writer, an access point, and the like.

14. The wireless communication failure monitoring system according to claim 7, wherein the sensor is at least one of a noise measuring device, temperature sensor, humidity sensor and dew condensation sensor.

15. The wireless communication failure monitoring system according to claim 7, wherein, in the monitoring device, when the measurement result causing a communication failure and a report situation of the communication execution report are shown as normal, maintenance responding processing is not performed but log analyzing processing based on the measurement result is performed; when the measurement result, which is an element causing a communication failure, and the report situation of the communication execution report are shown as abnormal, the log analyzing processing based on the measurement result and the maintenance responding processing are performed; and when the measurement result causing a communication failure is shown as abnormal but the report situation of the communication execution report is normal, the maintenance responding processing is not performed but the log analyzing processing based on the measurement result is performed.

16. A monitoring device, comprising:
a log storage section that receives and stores, from a wireless transmitting and receiving device, a log that is generated on the basis of a communication execution report indicating an execution result of wireless communication performed between a terminal device and the wireless transmitting and receiving device, and measurement result data indicating a measurement result of a communication environment variation element outputted from a sensor;
a log analyzing section that determines occurrence of a communication failure on the basis of the log stored in the log storage section; and
a reporting section that receives a command from the log analyzing section and executes predetermined processing in response to the command.

17. The monitoring device according to claim 16, wherein the log analyzing section determines the occurrence of a communication failure between the wireless transmitting and receiving device and the terminal device on the basis of the log stored in the log storage section, and the monitoring device further comprises a responding processing section that executes predetermined processing for dealing with the communication failure on the basis of the determination made by the log analyzing section.

18. The monitoring device according to claim 17, wherein the predetermined processing is remote operation processing for causing the wireless transmitting and receiving device to perform adjustment to fix the communication failure.

19. The monitoring device according to claim 17, wherein the predetermined processing is processing for transmitting a report for fixing the communication failure.

20. The monitoring device according to claim 17, wherein the predetermined processing is processing for generating a maintenance request message for sending a maintenance person to a location in which the wireless transmitting and receiving device is installed, and then transmitting the maintenance request message.

21. The monitoring device according to claim 17, wherein, when the measurement result causing a communication failure, and a report situation of the communication execution report are shown as normal, maintenance responding processing is not performed but log analyzing processing based on the measurement result is performed; when the measurement result causing a communication failure, and the report situation of the communication execution report are shown as abnormal, the log analyzing processing based on the measurement result and the maintenance responding processing are performed; and when the measurement result causing a communication failure is shown as abnormal but the report situation of the communication execution report is shown as normal, the maintenance responding processing is not performed but the log analyzing processing based on the measurement result is performed.
